(19) United States
(12) Patent Application Publication
(10) Pub. No.: US 2006/0012870 A1
(43) Pub. Date: Jan. 19, 2006

(54) Light scanning microscope with line-by-line scanning and use

(76) Inventors: Ralf Engelmann, Jena (DE); Ralf Wolleschensky, Apolda (DE); Joerg Steinert, Jena (DE); Dieter Schau, Lehesten (DE)

Correspondence Address: JACOBSON HOLMAN PLLC, 400 SEVENTH STREET N.W., SUITE 600, WASHINGTON, DC, 20004, US

(21) Appl. No.: 10/967,349

(22) Filed: Oct. 19, 2004

(30) Foreign Application Priority Data
Jul. 16, 2004 (DE) 10 2004 034 993.2

(51) Int. Cl. G02B 21/06

(52) U.S. Cl. 359/385; 359/368

(57) ABSTRACT

Light scanning microscope for recording at least one sample area by a relative movement between illumination light and sample, whereby an illumination light illuminated the sample in parallel in several spots or areas and several spots or areas are simultaneously detected with a detector arrangement and several illuminated sample points lie on a line and several points are simultaneously detected with a detector having local resolution whereby detection beams are provided with replaceable and/or switchable beam splitters and/or filters.

The invention describes a microscope that is very fast image pick-up having several freely configurable detection channels and good 3D resolution.

To achieve high image rates in the confocal and/or 4D microscopy, measures are necessary for paralleling the sample scanning. To date, this has meant a restriction in the resolution in 2D or 3D by non-changing confocal apertures (e.g. with a Nipkow disk) and a limitation of the number of detectors used and their fixed spectral allocation (generally an externally mounted CCD camera). This considerably limits the possible applications and samples and/or the quality of the image results in 3D.

A new, fast confocal and/or 4D microscope according to the invention distinguishes itself by the combination of high image rates by paralleling the sample scanning and an adjustable confocal aperture. In addition internal detectors are used, whose arrangement is such that several selectable color splitters split a flexible configuration of the detection channels. In this way, new applications in image pick-up become possible, which previously were not possible with fast confocal or 4D microscope. In particular, a separation/mixing of superimposed spectral signals like fluorescence signals can be carried out with fast change of the detection channels and the detected wave length, as is described in principle in DE19915137A1 and U.S. Pat. No. 6,028,306.

The invention can also be used advantageously with multi-point illumination as in U.S. Pat. No. 6,028,306 and Nipkow arrangements as in U.S. Pat. No. 6,028,306, WO8807695 and EP539691A.

In the following, the invention will be described in more detail by way of example with reference to the drawings.

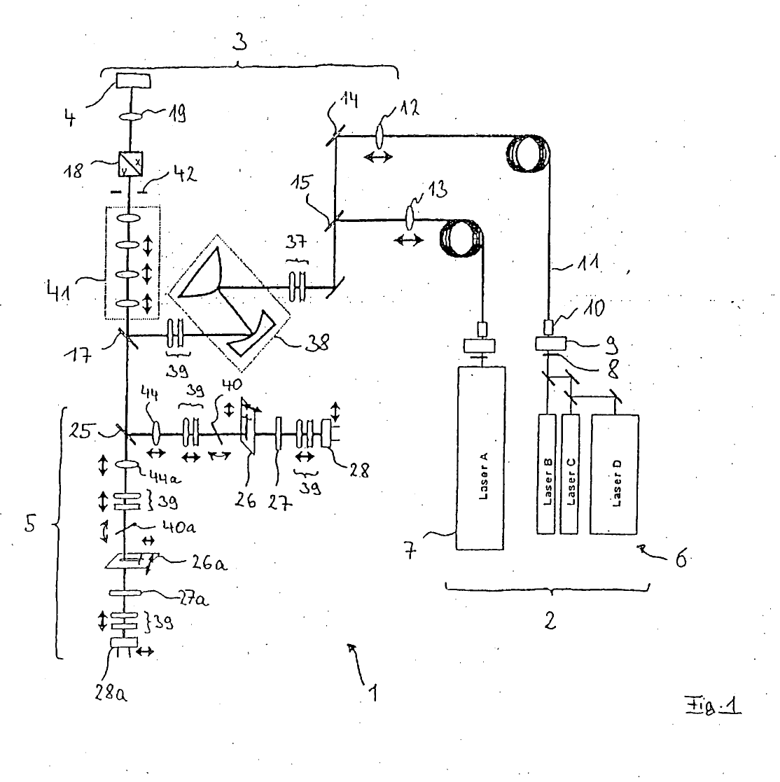

FIG. 1 shows, schematically, a laser scanning microscope 1, which is essentially constructed of five components: a radiation source module 2 that generates the excitation radiation for the laser scanning microscopy, a scanning module 3 that conditions the excitation radiation and suitably deflects it over the sample for scanning, a microscope module 4 that is shown only schematically for simplification which steers the scanning radiation prepared by the scanning module in a microscopic beam to the sample, as well as a detector module 5 that receives and detects optical radiation from the sample. In this case, the detector module 5 can be designed with several spectral channels as shown in FIG. 1. Reference is made to DE 19702753A1 for the general description of a point-by-point laser scanning microscope, which thus becomes a component of the present description.

The radiation source module 2 generates illumination radiation that is suitable for laser scanning microscopy, i.e. radiation that can trigger fluorescence. Depending on the application, the radiation source module has several radiation sources for this. In an embodiment shown, two lasers 6 and 7 are provided in the radiation source module 2, each of which has a light valve 8 and an attenuator 9 mounted after it and that couple their radiation over a coupling point 10 into a fiber optic cable 11. The light valve 8 acts as a beam deflector that can be used for beam shutoff without the operation of the laser in the laser unit 6 and/or 7 itself having to be turned off. The light valve 8 is designed as e.g. an AOTF that deflects the laser beam in the direction of a light trap that is not shown before coupling in the fiber optic cable 11 to turn the beam off.

In the example representation in FIG. 1, the laser unit 6 has three lasers, B, C, D, while on the other hand laser unit 7 has only one laser A. The representation is also an example of a combination of single and multi-wave length lasers which are coupled individually or also in common to one or more fibers. Also, the coupling can also occur by way of several fibers simultaneously whose beam is later mixed by a color combiner after passing through an adapting optics. Thus, it is possible to use all different wave lengths or ranges for the excitation radiation.

The radiation coupled in the fiber optic cable 11 is combined by means of movable collimation optics 12 and 13 over beam concentration mirrors 14, 15 and changed with respect to the beam profile in a beam-shaping unit.

The collimators 12, 13 provide that the radiation supplied by the radiation source module 2 to the scanning module 3 is collimated into an infinite beam path. In each case, this is advantageously carried out with a single lens that has a focusing function by sliding along the optical axis under the control of a central control unit (that is not shown) in that the distance between collimator 12, 13 and the respective end of the fiber optic cable can be changed.

The beam-forming unit, which will be explained in more detail below, generates, from the rotation-symmetrical, Gaussian profiled laser beam as is present after the beam concentration mirrors 14, 15, a line-shaped beam that is no longer rotation-symmetrical but is suitable in its cross section for generating a square illuminated field.

This illumination beam that is also referred to as line-shaped is used as the excitation radiation and will be guided over a main color splitter 17 and zoom optics, which are yet to be described, to a scanner 18. More details will be given later about the main color splitter, it only needs to be mentioned here that it has the function of separating the sample beam returning from the microscope module 4 from the excitation radiation.

The scanner 18 deflects the line-shaped beam in one or two axes, after which it is bundled by a scanning objective 19, as well as a tube lens and an objective of the microscope module 4 into a focus 22 that lies in a preparation and/or on a sample. The optical imaging is carried out in this process so that the sample will be illuminated with excitation radiation in a focal line.

This type of fluorescence radiation that is excited in a line-shaped focus goes over lens and tube lens of the microscope module 4 and the scanning objective 19 back to the scanner 18 so that in the return direction after scanner 18 a static beam is again present. Therefore, it is said that the scanner 18 de-scans the fluorescence radiation.

The main color splitter 17 allows the fluorescence radiation lying in wave length ranges other than that of the excitation radiation to pass through so that it is diverted over a deviation mirror 24 in detector module 5 and can then be analyzed. In the embodiment in FIG. 1, the detector module has several spectral channels, i.e. a fluorescence radiation coming from the deviation mirror 24 will be divided into two spectral channels in an auxiliary color splitter 25.

Each spectral channel has a slotted diaphragm 26 that creates a confocal or semi-confocal image with respect to sample 23 and whose size is specified by the depth of focus with which the fluorescence radiation can be detected. The geometry of the slotted diaphragm 26 thus determines the cross section plane within the (thick) preparation from which the fluorescence radiation is detected.

The slotted diaphragm 26 has a block filter 27 mounted after it that blocks undesirable excitation radiation that has gotten to the detector module 5. The line-shaped, fanned out radiation coming from a specific deep section that is separated in this way will then be analyzed by a suitable detector 28. The second spectral detection channel, which also comprises a slotted diaphragm 26a, a blocking filter 27a and a detector 28a, is also designed analogously to the color channel described.

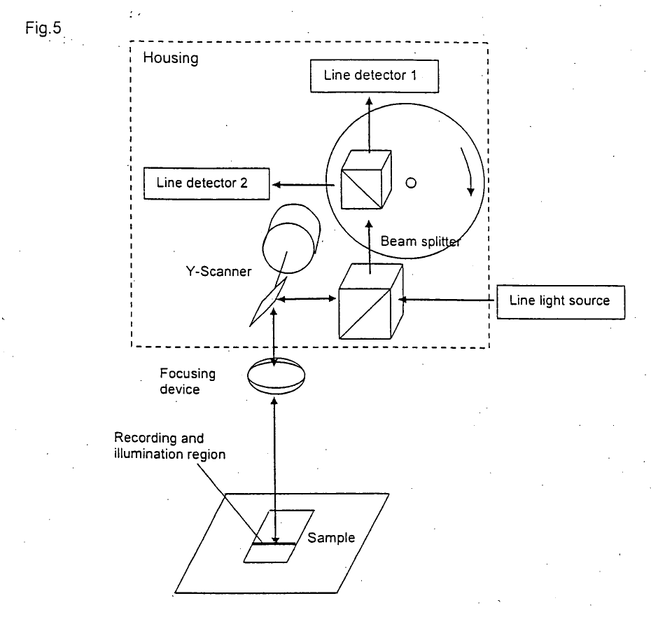

The use of a confocal slot aperture in the detector module 5 is only used as an example. Naturally, a single point scanner can also be produced. The slotted diaphragms 26, 26a are then replaced by aperture diaphragms and the beam-forming unit can be eliminated. Also, for a construction such as this, all optics are designed with rotation symmetry. Then naturally instead of a single point scanning and detection, in principle any multi-point arrangements like scatter plots or Nipkow disk concepts can be used, which will be explained further using FIGS. 3 and 4. However, what is important is that the detector 28 has local resolution since a parallel recording of several sample points is carried out when passing through the scanner. The illumination arrangement with the aspherical unit 38 can be used for uniform filling of a pupil between a tube lens and a lens. In this way, the optical resolution of the lens can be fully utilized. This variation is thus also effective in a microscope system that scans single points or multiple points, e.g. in a line-scanning system (in the latter additionally to the axis, in which focusing on or in the sample is carried out).

FIG. 1 shows that the movable, i.e. sliding, collimators 12 and 13 combine Gaussian beam bundles that are present over mirror steps in the form of beam-combining mirrors 14, 16 and in the construction type shown with confocal slotted diaphragm, are then converted into a beam bundle with square beam cross section. In the embodiment in FIG. 1, in the beam-forming unit a cylinder telescope 37 is used, which has an aspherical unit 38 mounted after it, followed by cylinder optics 39. After shaping, a beam is present that in its profile plane essentially illuminates a square field, whereby the intensity distribution along the field's longitudinal axis is not Gaussian but box-shaped.

The illumination arrangement with the aspherical unit 38 can be used for uniform filling of a pupil between a tube lens and a lens. In this way, the optical resolution of the lens can be fully utilized. This variation is thus also effective in a microscope system that scans single points or multiple points, e.g. in a line-scanning system (in the latter additionally to the axis, in which focusing on or in the sample is carried out).

The e.g. line-shaped conditioned excitation radiation is guided to the main color splitter 17. This is designed, in a preferred embodiment, as spectral-neutral separating mirrors according to DE 10257237 A1, whose disclosure is included here in its full scope. The term “color splitter” thus also includes splitter systems that do not work spectrally. Instead of the spectral independent color splitter that has been described, a homogeneous neutral splitter (e.g. 50/50, 70/30, 80/20, etc.) or a dichroic splitter can also be used. In this way, a selection is possible depending on the application, if the main color splitter is preferably provided with a mechanical device that makes change simple, e.g. by a corresponding splitter wheel that contains individual replaceable splitters.

A dichroic main color splitter is especially advantageous when coherent, i.e. directional beams will be detected, e.g. reflection, Stokes and/or anti-Stokes Raman spectroscopy, coherent Raman processes of a higher order, generally parametric non-linear optical processes like second harmonic generation, third harmonic generation, sum frequency generation, double photon and multi-photon absorption and/or fluorescence. Several of these methods of non-linear optical spectroscopy require the use of two or more laser beams that are superimposed in a collinear way. In this case, the beam concentration of beams from several lasers has proven to be especially advantageous. Basically, in fluorescence microscopy, widely available dichroic beam splitters can be used. Also, for Raman microscopy, it is advantageous to use holographic notch splitters or filters before the detectors for suppression of the Rayleigh scatter portion.

In the embodiment in FIG. 1, the excitation radiation and/or illumination radiation is supplied to the scanner 18 by way of zoom optics 41 that can be controlled with a motor. In this way, the zoom factor can be adjusted and the scanned visual field can be varied continuously within a specific adjusting range. Especially advantageous are zoom optics in which the pupil position is maintained in the continuous tuning process during adaptation of the focus location and the imaging scale. The three motor degrees of freedom of zoom optics 41 shown in FIG. 1 and symbolized with arrows correspond precisely to the number of degrees of freedom that are provided for adjustment of the three parameters image scale, focus position and pupil position. Especially preferred are zoom optics 41 that have a fixed shutter 42 mounted on its output pupil diaphragm. In a practical simple implementation, the shutter 42 can also be produced by the limitation of the mirror surface of scanner 18. The output side shutter 42 with zoom optics 41 have the result that a specified pupil diameter can always be displayed on the scanning objective 19 independently of the adjustment of the zoom enlargement. Thus, the objective pupil remains completely illuminated even during any adjustment of the zoom optics 41. The use of an independent shutter 42 advantageously prevents the occurrence of undesirable scatter radiation in the area of the scanner 18.

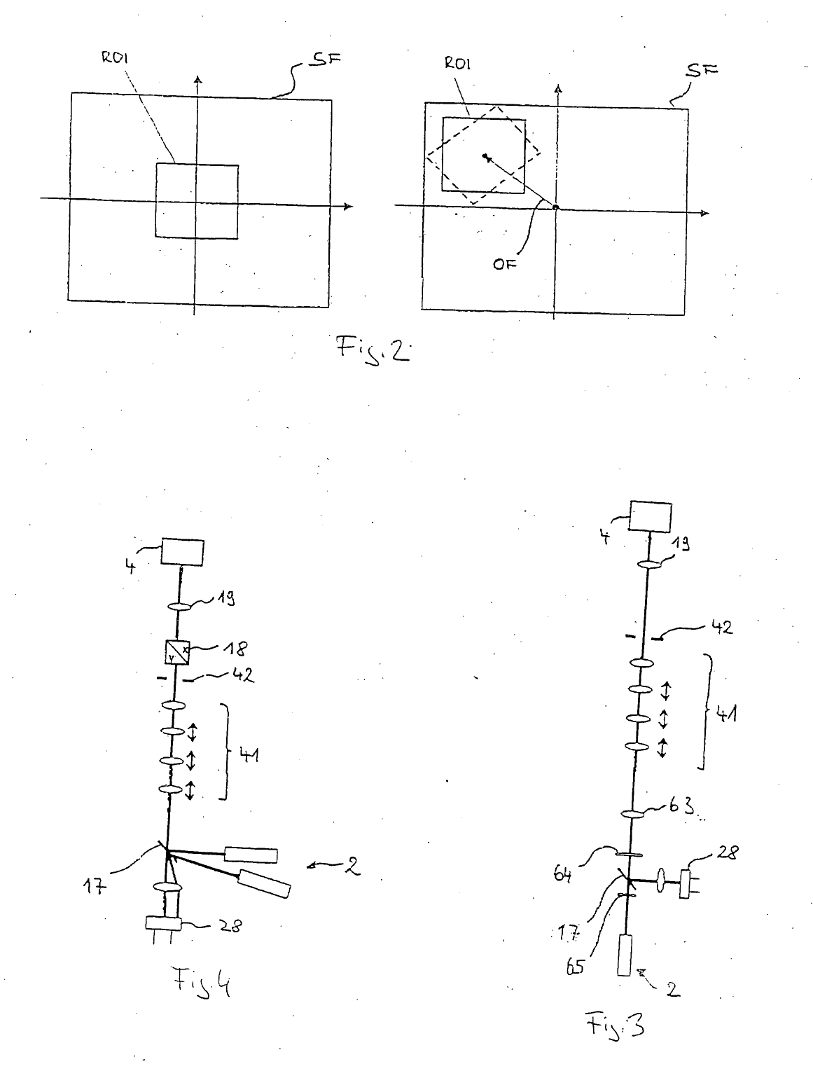

The cylinder telescope 37, which can also be operated with a motor and is mounted before the aspherical unit 38, works together with zoom optics 41. This has been selected in the embodiment in FIG. 2 for reasons of a compact structure but need not necessarily be this way.

If a zoom factor less than 1.0 is desired, the cylinder telescope 37 is automatically swiveled into the optical beam. It prevents the aperture diaphragm 42 from being incompletely illuminated when the zoom objective 41 is reduced. The swiveling cylinder telescope 37 thus guarantees that even with zoom factors less than 1, i.e. independent of the adjustment of zoom optics 41, an illumination line of a constant length will always be present at the location of the objective pupil. In comparison to the simple visual field zoom, laser power losses are thus prevented in the illumination beam.

Since when the cylinder telescope 37 is swiveled in, a jump in display brightness is unavoidable in the illumination line, a provision is made in the control unit (not shown) that the traversing speed of scanner 18 or an amplification factor of the detectors in detector module 5 is adapted accordingly with active cylinder telescope 37 in order to keep the display brightness constant.

In addition to the zoom optics 41 driven by a motor as well as the cylinder telescope 37 that can be activated with a motor, remote controlled adjusting elements are also provided in the detector module 5 of the laser scanning microscope in FIG. 1. For compensation of color longitudinal errors, for example, round optics 44 and cylinder optics 39 are mounted before the slotted diaphragm and cylinder optics 39 are provided directly before the detector 28, and each of these can be moved in axial direction with a motor.

In addition, a correction unit 40, which will be described briefly below, is provided for compensation.

The slotted diaphragm 26, together with round optics 44 mounted in front of it and the first cylinder optics 39 also mounted in front of it and the second cylinder optics mounted after it, forms a pinhole objective in detector arrangement 5, whereby the pinhole is implemented here by the slotted diaphragm 26. In order to prevent the undesirable detection of excitation radiation reflected in the system, the second cylinder lens 39 also has a blocking filter 27 before it that has suitable spectral properties to allow only desirable fluorescence radiation to get to detector 28, 28a.

A change in the color splitter 25 or the blocking filter 27 unavoidably causes a certain tipping or wedge error during swiveling. The color splitter can cause an error between sample area and slotted diaphragm 26, the blocking filter 27 can cause an error between the slotted diaphragm 26 and detector 28. In order to prevent the necessity of a recalibration of the position of the slotted diaphragm 26 and/or the detector 28, a plane parallel plate 40 is mounted between round optics 44 and the slotted diaphragm 26, i.e. in the image beam between sample and detector 28, which can be brought into different tipped positions under the control of a controller. For this purpose, the plane parallel plate 40 is mounted in an adjustable bracket. FIG. 2 shows how an area (region of interest) ROI can be selected with the help of the zoom optics 41 within the maximum scan field SF that is available. If the control of the scanner 18 is left such that the amplitude does not change, as is absolutely necessary e.g. with resonance scanners, an enlargement greater than 1.0 set on the zoom optics causes a constriction of the selected ROI, centered around the optical axis of the scan field SF. Resonance scanners are described, for example, in Pawley, Handbook of Biological Confocal Microscopy, Plenum Press 1994, page 461ff. If the scanner is controlled in such a way that it scans a field asymmetrically to the optical axis, i.e. to the rest position of the scanner mirror, an offset displacement OF of the selected ROI will be obtained in connection with a zoom effect. Because of the effect of the scanner 18 to descan, as already mentioned, and by the repeat passage through the zoom optics 41, the selection of the region of interest ROI in the detection beam path will again be lifted in the direction of the detector. In this way, a selection lying within the scan image SF can be made for the region of interest ROI. In addition, images can be obtained for different selections of the region of interest ROI, and these can be combined to a high resolution image.

If the goal is not only to move the selected range of interest ROI by an offset OF with respect to the optical axis, but additionally to rotate it, an embodiment is effective that provides an Abbe-König prism in a pupil in the beam path between main color splitter 17 and sample 23, which results in an image field rotation, as is known. Also, this will be lifted in the direction of the detector. Now images with different offset displacements OF and different rotation angles can be measured and then put together to make a high resolution image, for example according to an algorithm as is described in the publication Gustafsson, M., “Doubling the lateral resolution of wide-field fluorescence microscopy using structured illumination,” in “Three-dimensional and multidimensional microscopy: Image acquisition processing VII,” Proceedings of SPIE, Vol. 3919 (2000), pages 141-150.

FIG. 3 shows another possible construction type for a laser scanning microscope 1, in which a Nipkow disk attachment is used. The light source module 2, which is shown greatly simplified in FIG. 3, illuminates, over a mini-lens array 65 through the main color splitter 17, a Nipkow disk 64 as is described in U.S. Pat. No. 6,028,306, WO 88 07695 or DE 2360197 A1. The pinholes of the Nipkow disk illuminated by the mini-lens array 65 are imaged on the sample found in the microscope module 4. Zoom optics 41 are provided here as well to be able to vary the image size on the sample side.

As a change to the construction in FIG. 1, in the Nipkow scanner the illumination is carried out in the passage through the main color splitter 17 and the radiation to be detected will be mirrored. In addition, as a change from FIG. 2, the detector 28 is now designed so that it has local resolution so that the multi-point illumination achieved with the Nipkow disk 64 can also be scanned in parallel. In addition, suitable fixed optics 63 with positive refractive power are mounted between the Nipkow disk 64 and the zoom optics 41, which converts divergent radiation coming through the pinholes of the Nipkow disk 64 into a suitable bundle diameter. The main color splitter 17 for the Nipkow construction in FIG. 3 is a classic dichroic beam splitter, i.e. not the beam splitter mentioned above with slot-shaped or point-shaped reflecting area.

The zoom optics 41 correspond to the previously explained construction whereby naturally the scanner 18 becomes superfluous because of the Nipkow disk 64. However, it can still be provided if the selection of a region of interest ROI will be carried out as explained using FIG. 2. The same is true of the Abbe-König prism.

FIG. 4 shows an alternative solution schematically with multi-point scanning, in which several light sources radiate diagonally into the scanner aperture diaphragm. Here as well, because of the use of the zoom optics 41, a zoom function as shown in FIG. 2 can be implemented for imaging between main color splitter 17 and scanner 18. By simultaneous radiation of light bundles at different angles in a plane conjugate to a pupil, light points will be generated in a plane conjugate to the lens plane that are guided by scanner 18 simultaneously over a partial area of the entire lens field. The image information is developed by evaluation of all the partial images on a local resolution matrix detector 28.

Another embodiment that can be considered is a multi-point scanning as described in U.S. Pat. No. 6,028,306, the disclosure of which is included here in its full scope in this regard. Here as well, a local resolution detector 28 is provided. The sample is then illuminated by a multi-point light source that is implemented by a beam expander with downstream micro-lens array, which illuminates a multi-aperture plate in such a way that a multi-point light source is implemented.

direction of the detector. In this way, a selection lying within the scan image SF can be made for the region of interest ROI. In addition, images can be obtained for different selections of the region of interest ROI, and these can be combined to a high resolution image.

FIG. 5 shows and example of an arrangement of 2 internal detectors with a replaceable beam splitter for detection of several colors on a fast (paralleling) line scanner. The use of a schematically represented line scanner (see FIG. 1 in detail) shows that by means of replaceable dichroic beam splitters, e.g. over a splitter wheel T, a change can be made very quickly between different spectral detection wave lengths and a parallel detection using several line detectors, as indicated here, for example, with 1 and 2.

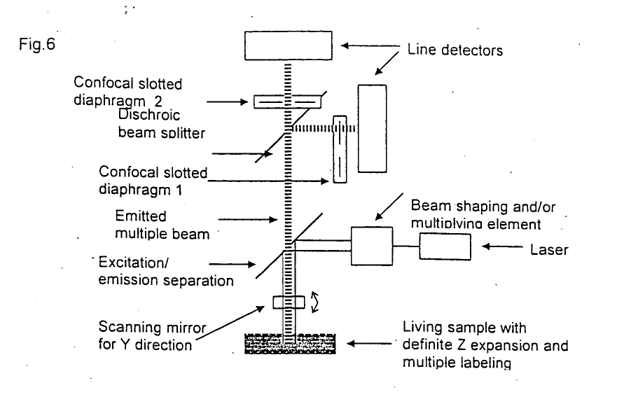

FIG. 6 shows an arrangement of an adjustable confocal slotted diaphragm for better 3D detection through optical section placement on a fast (paralleling) line scanner. In this case, an adjustable slotted diaphragm is shown schematically, as an alternative or additionally to be able to vary the layer thickness in Z direction to change the spectral detection mode. In the case of a beam multiplication with axial or lateral slot, instead of a dichroic beam splitter, a neutral splitter can also be used. The light paths that are offset to each other axially and/or laterally can be selectively directed to the slotted diaphragms of the detectors, for example by appropriate axial and/or lateral positioning. The invention described represents an important expansion of the application possibilities of fast confocal laser scanning microscopes. The importance of such a further development can be understood from reading the standard cell biology literature and the fast cellular and subcellular processes¹ described there and the testing methods used there with a large number of dyes².

For example, see:
¹B. Alberts et al. (2002): Molecular Biology of the Cell; Garland Science.
^{1,2}G. Karp (2002): Cell and Molecular Biology: Concepts and Experiments; Wiley Text Books.
^{1,2}R. Yuste et al. (2000): Imaging neurons—a laboratory Manual; Cold Spring Harbor Laboratory Press, New York.
²R. P. Haugland (2003): Handbook of fluorescent Probes and research Products, 10th Edition; Molecular Probes Inc. and Molecular Probes Europe BV.

The invention has especially great importance for the following processes and procedures:

Development of Organisms

The invention described is suitable, among other things, for the examination of development processes, which are mainly characterized by dynamic process in the range of tenths of a second to hours. Example applications on the level of symplasts and complete organisms are described here as an example:
Abdul-Karim, M. A. et al. describe, in 2003 in Microvasc. Res., 66:113-125, a long-term analysis of blood vessel changes in the living animal, wherein fluorescence images were recorded at intervals over several days. The 3D data records were evaluated with adaptive algorithms in order to schematically represent movement trajectories.
Soll, D. R. et al. describe, in 2003 in Scientific World Journ. 3:827-841, a software-based movement analysis of microscopic data of nuclei and pseudopods of living cells in all 3 spatial dimensions.
Grossmann, R. et al. describe, in 2002 in Glia, 37:229-240 a 3D analysis of the movements of rat microglial cells, whereby the data were recorded over up to 10 hours. At the same time, there were also fast reactions of the glia after traumatic, so that a high data rate and corresponding data volume occurred. This relates especially to the following focal points:
Analysis of living cells in 3D environment, whose adjacent cells react sensitively to laser illumination and have to be protected from the illumination of the 3D-ROI;
Analysis of living cells in 3D environment with labels, that will be selectively bleached by laser light in 3D, e.g. FRET experiments;
Analysis of living cells in 3D environment with labels, that will be selectively bleached by laser light in 3D and simultaneously will also be observed outside the ROI, e.g. FRAP AND FLIP experiments;
Selective analysis of living cells in 3D environment with labels and pharmaceuticals that exhibit manipulation-related changes due to laser illumination, e.g. activation of transmitters in 3D;
Selective analysis of living cells in 3D environment with labels that exhibit manipulation-related color changes due to laser illumination, e.g. paGFP, Kaede;
Selective analysis of living cells in 3D environment with vary weak labels that e.g. require an optimum balance of confocality and detection sensitivity.
Living cells in a 3D tissue structure with varying multiple labels, e.g. CFP, GFP, YFP, DsRed, HcRed, etc.
Living cells in a 3D tissue structure with labels, that have color changes depending on function, e.g. Ca⁺-Marker
Living cells in a 3D tissue structure with labels, that have color changes due to development, e.g. transgenic animals with GFP
Living cells in a 3D tissue structure with labels, that have manipulation-related color changes due to laser illumination, e.g. paGFP, Kaede
Living cells in a 3D tissue structure with very weak labels that require a restriction of the confocality in favor of the detection sensitivity.
The latter-named point in combination with the preceding.
   Transport Processes in Cells

The invention described is excellently suited for the examination of intercellular transport processes, since in this case very small motile structures, e.g. proteins, have to be represented at high speeds (usually in the range of hundredths of a second). In order to record the dynamics of complex transport processes, such applications as FRAP with ROI bleaching are also often used. Examples of such studies are described here:
Umenishi, F. et al. describe, in 2000 in Biophys J., 78:1024-1035 an analysis of the spatial movement capability of Aquaporin in GFP-transfected culture cells. To do this, spots in the cell membranes are selectively bleached locally and the diffusion of the fluorescence in the environment is analyzed.
Gimpl, G. et al. describe, in 2002 in Prog. Brain Res., 139:43-55 experiments with ROI bleaching and fluorescence imaging for analysis of the mobility and distribution of GFP-labeled oxytocin receptors in fibroblasts. IN this process, there are high demands of spatial positioning and resolution, as well as the immediate time sequence of bleaching and imaging.
Zhang et al. describe, in 2001 in Neuron, 31:261-275 live cell Imaging of GFP-transfected nerve cells, whereby the movement of granuli was observed by combined bleaching and fluorescence imaging. The dynamics of the nerve cells here make the greatest demands on the imaging speed.
   Interactions of Molecules

The invention described is especially suitable for the display of molecular and other subcellular interactions. In this case, very small structures must be displayed at high speed (in the range of hundredths of a second). In order to resolve the spatial position of the molecules necessary for the interaction, indirect techniques like FRET with ROI bleaching are also used. Example applications are described here:
Petersen, M. A. und Dailey, M. E. describe, in 2004 in Glia, 46:195-206 a two-channel recording of living hypocampus cultures in the rat, whereby the two channels are recorded spatially in 3D and over a longer period of time for the labels lectin and sytox.
Yamamoto, N. et al. describe, in 2003 in Clin. Exp. Metastasis, 20:633-638 a two-color imaging of human fibrosarcoma cells, whereby green and red fluorescent protein (GFP and RFP) were viewed simultaneously in real time.
Bertera, S. et al. describe, in 2003 in Biotechniques, 35:718-722 a multi-color imaging of transgenic mice labeled with timer reporter protein, which changes its color from green to red after synthesis. The image recording is carried out as fast series 3-dimensional in the tissue of the living animal.
   Signal Transfer Between Cells

The invention described is outstandingly well suited to the examination of most extremely fast signal transfer processes. These mostly neurophysiological processes make the highest demands of time resolution, since the activities mediated by ions proceed in the range of hundredths to less than thousandths of a section. Example applications of examinations in muscle or nervous systems are described here as an example:
Brum G et al. describe, in 2000 in J. Physiol. 528: 419-433, the localization of fast Ca+ activities in muscle cells of the frog after excitation with caffeine as a transmitter. The localization and the micrometer-precise resolution could only be achieved with the use of a fast confocal microscope.
Schmidt H et al. describe, in 2003 in J. Physiol. 551:13-32, and analysis of Ca+ ions in nerve cell continuations of transgenic mice. The examination of fast Ca+ transients in mice with modified Ca+ binding proteins could only be carried out with high-resolution confocal microscopy, since the localization of the Ca+ activity inside the nerve cells and their precise time kinetics also play an important role.

1-10. (canceled)

11. Light scanning microscope for recording at least one sample area by a relative movement between illumination light and a sample, comprising:
illuminating means for providing an illumination light for illuminating a sample in parallel in one of several spots and areas and, wherein several illuminated sample points lie in a line,
means for providing relative movement between the illumination light and the sample,
detector means for simultaneously detecting one of several spots and areas, wherein the detector means has local resolution and simultaneously detects several points, and wherein the detector means is provided with at least one detection channel, and
at least one of a replaceable beam splitter and a switchable beam splitter and a replaceable filter and a switchable filter provided in each detection channel.

12. Light scanning microscope according to claim 11, further comprising adjustable confocal shutters for changing the optical section thickness.

13. Light scanning microscope according to claim 12, wherein the detector means comprises several internal detectors having at least one of switchable beam splitters and replaceable beam splitters provided for wave length assignment.

14. Light scanning microscope according to claim 13, further comprising means for synchronous triggering of spectral detection and shutter adjustment.

15. Light scanning microscope according to claim 11, wherein the illuminating means illuminates several illumination regions in parallel,
wherein the light scanning microscope comprises several detector means, each detector means being assigned to an illumination region, and
wherein the light scanning microscope further comprises means for carrying out fluorescence spectra recording using fast changing of the spectral channels, and means for spectral separation of different wave lengths using a demixing process.

16. Light scanning microscope according to claim 11, further comprising one of a resonance scanner, a Nipkow scanner, and a multipoint scanner.

17. Process for examining development processes, comprising the step of:
studying dynamic processes in the range of a tenth of a second up to hours, at the level of united cell structures and entire organisms, using the light scanning microscope according to claim 11.

18. Process according to claim 17, wherein the studying step comprises analyzing living cells in a 3D-environment with markings which are intended to be selectively bleached by laser illumination in 3D.

19. Process for studying intercellular transport processes, comprising the step of:
displaying small motile structures with high speed, using the light scanning microscope according to claim 11.

20. Process for displaying molecular and other subcellular interactions, comprising the step of:
displaying very small structures with high speed for the resolution of submolecular structures, using the light scanning microscope according to claim 11.

21. Process for studying fast signal transmission processes, comprising the step of:
studying neurophysiological processes with high temporal resolution in studies in the muscle or nerve system, using the light scanning microscope according to claim 11.
